(19) United States
(12) Patent Application Publication
(10) Pub. No.: US 2012/0323498 A1
(43) Pub. Date: Dec. 20, 2012

(54) MIRFILTER: EFFICIENT NOISE REDUCTION METHOD TO IDENTIFY MIRNA AND TARGET GENE NETWORKS FROM GENOME-WIDE EXPRESSION DATA

(75) Inventor: Inhan Lee, Ann Arbor, MI (US)

(73) Assignee: The Regents of the University of Michigan, Ann Arbor, MI (US)

(21) Appl. No.: 13/579,896

(22) PCT Filed: Feb. 22, 2011
(86) PCT No.: PCT/US11/25726

§ 371 Date: Aug. 17, 2012

Related U.S. Application Data
(60) Provisional application No. 61/306,355, filed on Feb. 19, 2010.

(51) Int. Cl. G06F 19/20

(52) U.S. Cl. 702/20

(57) ABSTRACT

A computer implemented method of identifying potential micoRNA targets and biomarkers comprises receiving data identifying a first set of mRNA sequences into computer accessible memory. Each mRNA sequence in the first set has a region that is upstream of a translation start site, a region that is downstream of a translation stop site, and an open reading frame. The method further comprises receiving data identifying a second set of microRNA (miRNA) sequences into the computer accessible memory. Each microRNA sequence has a 5′ miRNA section and a 3′ miRNA section. Each mRNA sequence is characterized by an expression pattern in the first set as being up-regulated, down-regulated, or uncharged as compared to a control sample and each miRNA sequence in the second set as being up-regulated, down-regulated, or uncharged as compared to the control sample. It is then determined which mRNA sequences from the first set are susceptible to being regulated by microRNA from the second set. A set of consistent relationships is identified between the miRNA and the mRNA determined from the mRNAs that have been characterized.

### CROSS-REFERENCE TO RELATED APPLICATIONS

This application claims the benefit of U.S. provisional Application No. 61/306,355 filed Feb. 19, 2010, the disclosure of which is incorporated in its entirety by reference herein.

### FIELD OF THE INVENTION

The present invention relates to methods of predicting miRNA targets and integrative biomarkers from miRNA and mRNA expression patterns. Such methods find use in research, diagnostic and therapeutic settings (e.g., to discover targets, drugs, diagnostic products, etc.).

### BACKGROUND

Identifying disease-relevant pathways using large genome-wide datasets pose distinct challenges. The data is vast, diverse, and inherently complex, being derived from DNA, mRNA, non-coding RNA, and protein levels, so that little progress has been made towards combining multiple platform datasets. Even dealing with one platform, the sheer bulk of data forces researchers to focus on previously known genes, rather than new genetic mechanisms, due to a lack of tools generating pathways in a hypothesis-free manner It has become clear that most diseases are due to a combination of genetic and environmental factors and that genetic factors themselves are due to combined effects of multiple genes rather than one bad gene, especially for diseases with complex causes and symptoms. Seeing how a single miRNA could regulate several mRNAs and a single mRNA could be regulated by several miRNAs, we set out to identify multiple disease-relevant genes by combining expression data from two platforms, miRNA and mRNA.

Most miRNAs are transcribed similarly to other protein-coding genes, processed by Drosha enzyme into a hairpin-shaped precursor which is transported into the cytosol for further processing by Dicer enzyme until a single strand of mature miRNA is loaded into RNA-induced silencing complex (RISC), making a functional miRNA-protein complex (miRNP). Translation repression by a miRNA occurring in a sequence-specific way can present mild to significant mRNA degradation, probably due to the secondary effect of other enzymes after localization of mRNA-miRNP complexes in the cytosolic loci. As human mature miRNAs number 722 (including 167 star-named sequences) in miRBase version 10.0 as of 2008 and all human mRNAs total about 20,000, one miRNA may regulate many genes in a single biological context. In fact, many miRNA target-finding programs predict several hundreds to thousands of target genes for one miRNA. However, many of these predicted targets turn out to be false positives, constituting a major hurdle in understanding miRNA function.

Accordingly, there is a need for improved method of evaluating mRNA and miRNA expression patterns.

### SUMMARY OF THE INVENTION

The present invention solves one or more problems of the prior art by providing in one embodiment, a computer implemented method of identifying potential micoRNA targets and biomarkers. The method comprises receiving data identifying a first set of mRNA sequences into computer accessible memory. Each mRNA sequence in the first set has a region that is upstream of a translation start site, a region that is downstream of a translation stop site, and an open reading frame. The method further comprises receiving data identifying a second set of microRNA (miRNA) sequences into the computer accessible memory. Each microRNA sequence has a 5′ miRNA section and a 3′ miRNA section. Each mRNA sequence is characterized by an expression pattern in the first set as being up-regulated, down-regulated, or uncharged as compared to a control sample and each miRNA sequence in the second set as being up-regulated, down-regulated, or uncharged as compared to the control sample. It is then determined which mRNA sequences from the first set are susceptible to being regulated by microRNA from the second set. A set of consistent relationships is identified between the miRNA and the mRNA determined from the mRNAs that have been characterized, a consistent relationship being a relationship in in which up regulation of an mRNA is associated with down regulation of an associated microRNA and down regulation of the mRNA is associated with up regulation of the associated microRNA or up regulation of an mRNA is associated with up regulation of an associated microRNA and down regulation of the mRNA is associated with down regulation of the associated microRNA.

In another embodiment, a non-transitory computer readable medium having instructions encoded thereon. The instructions are executable by a computer processor to perform the method steps set forth above is provided. Specifically, the computer readable medium is encoded with instructions for the steps of the methods of the invention. Example of useful computer readable media include, but are not limited to, harddrives, floppy drives, CDROM, DVD, optical drives, random access medium, and the like.

### DESCRIPTION OF THE DRAWINGS

Exemplary embodiments of the invention will become more fully understood from the detailed description and the accompanying drawings, wherein:

FIG. 1 is a schematic illustration of a computer system implementing an embodiment of the invention;

FIG. 2 is a schematic flowchart illustrating an embodiment of the invention;

FIG. 3 is a schematic illustration of the microRNA and mRNA used in embodiments of the invention;

FIGS. 4A-G provide a table showing eigenvectors for miRNA expression space;

FIG. 5 provides characteristics of computationally predicted miRNA targets, ours and Targetscan's. (a) Frequency graph for the number of regulating miRNAs to target a common gene, ours in triangle, TargetScan CC in solid line, TargetScan CL in dotted line, Targetscan N in square. (b, c) Frequency bar graphs of target gene number for a single miRNA, ours shown in solid black, TargetScan CC in cross hatch, CL in solid grey, and N in white fill. The frequency bin in (b) is 50 and in (c) 500. (b) is normalized due to the difference in total target gene numbers between ours and CC;

FIG. 6 provides all Duchenne muscular dystrophy gene networks from mirFilter and a proposed schematic based on one of the networks miRNAs and mRNAs identified by mirFilter are surrounded by squares. Dotted squares represent additional miRNAs identified for the mRNA when a less stringent FR filter is used rather than FRG. Up- and down-regulated miRNAs or mRNAs are indicated by up- and down-arrows next to these squares. The uncolored box indicates expressions of miRNA not measured directly but whose opposing strand in the same hairpin pre-miRNA has been measured and found to be negatively-correlated. A question mark is used instead of up or down arrows in such cases. The network annotations are the same in FIGS. 8, 9, and 10;

FIG. 7 provides a table showing Dmd networks using regulation matrix based on TargetScan;

FIG. 8 provides all schizophrenia gene networks from mirFilter and a proposed presynaptic mechanism based on some of the networks. The presynaptic vesicle cycle is shown with glutamate molecules as an example of a neurotransmitter. However, other neurotransmitters using vesicles may play a role in low excitation as well. We propose that up-regulated ATP6V1B2 blocks the step following glutamate uptake. A PFN2 mutant mice study suggests increased exocytosis, but the exact functional site is not known;

FIG. 9 provides A) all metastatic cell line signatures from mirFilter and B) the verifications of all miRNA targets using luciferase assay. Among the miRNA signatures miR-200 and miR-335 are well-known miRNAs preventing metastasis; and

FIG. 10 provides the mirFilter outputs using protein expression rather than mRNA expression in FIG. 9. Using totally different coding gene expression data (none of mRNA expressions in FIG. 10). MirFilter still identifies miR-200 as a metastatic signature.

### DETAILED DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

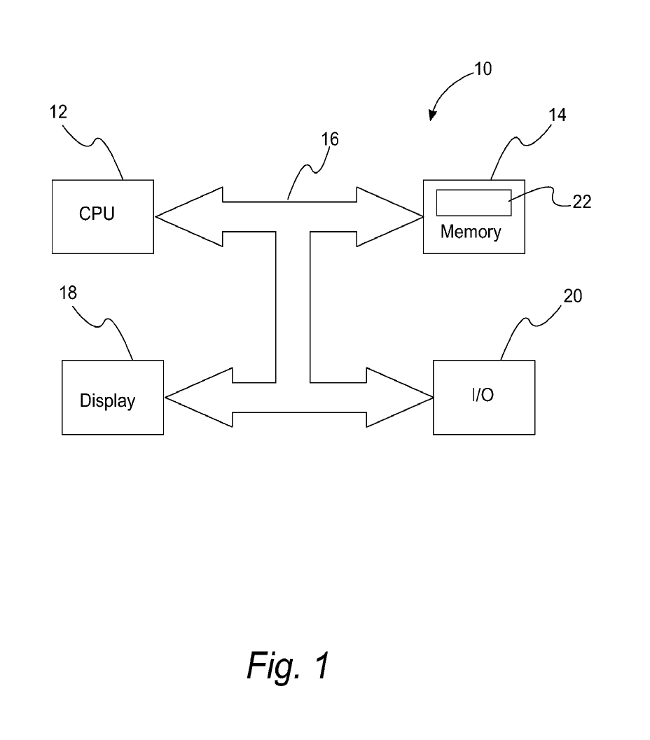

With reference to FIG. 1, the present invention provides a computer system for determining mRNA sequences that are susceptible to regulation by microRNA. System 10 of the present invention includes central processing unit (CPU) 12, memory 14, and input/output interface 16. Computer system 10 communicates with display 18 and input devices 20 such as a keyboard and mouse via interface 16. In one variation, memory 14 includes one or more of the following: random access memory (RAM), read only memory (ROM), CDROM, DVD, disk drive, flash drive, tape drive and the like. The method of various embodiments is implemented by routine 22 that is stored in memory 14 and executed by the CPU 12.

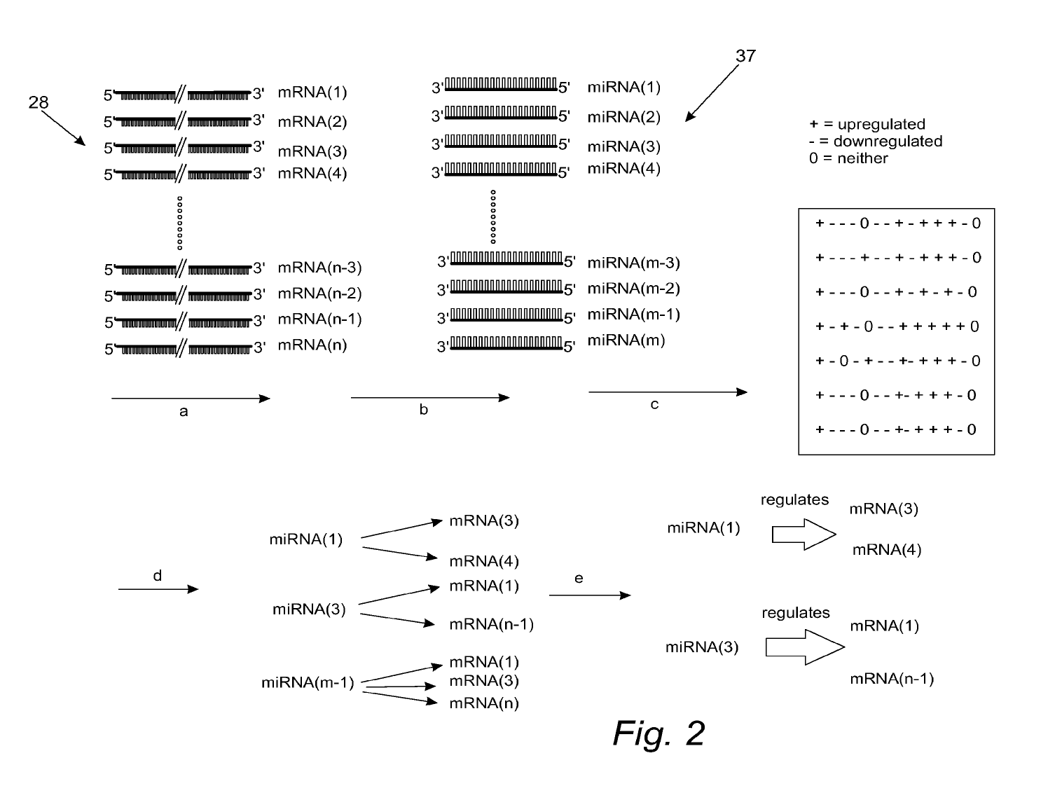

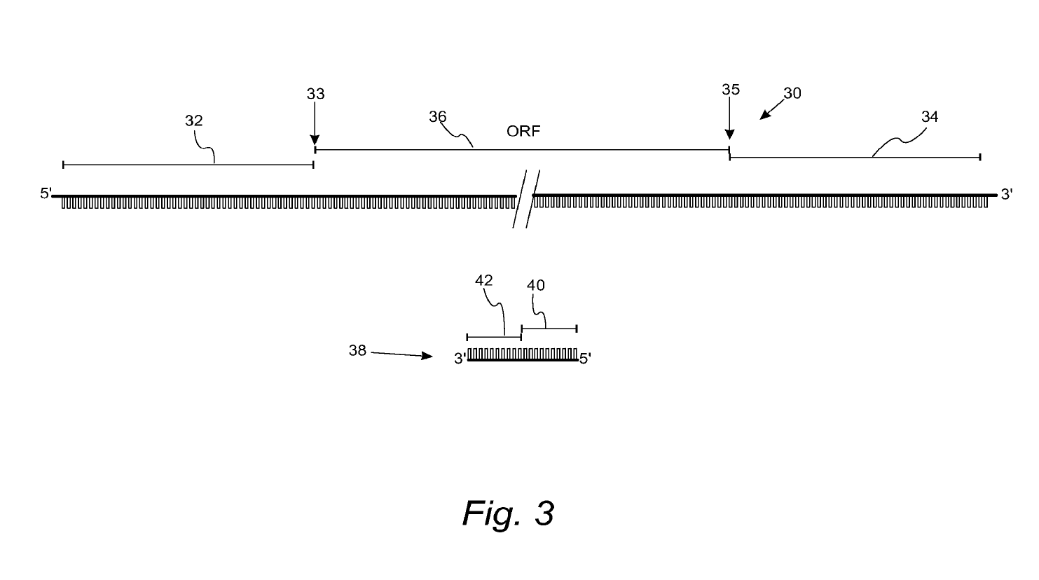

With reference to FIGS. 2 and 3, the method implemented by routine 22 includes step a) of receiving data identifying set 28 of mRNA sequences. The method is referred to herein as the “mirFilter.” Each mRNA sequence 30 in set 28 has a region 32 that is upstream of translation start site 33, a region 34 that is downstream of translation stop site 35, and an open reading frame 36. In a refinement, region 32 includes a 5′ untranslated region (UTR). In another refinement, region 34 includes a 3′ UTR. Candidate mRNA sequences can be downloaded from http://www.ncbi.nlm.nih.gov/. The method also includes step b) of receiving data identifying set 37 of microRNA (miRNA) sequences. Candidate miRNA sequences can be downloaded from http://mirbase.org/ftp.shtml. The microRNA sequence 38 has 5′ miRNA section 40 and a 3′ miRNA section 42. In one refinement, 5′ miRNA section 40 has a length equal to the length of the miRNA divided by 2 rounded down to the nearest integer. The 5′ miRNA section 40 starts from the 5′ end of the miRNA. In another refinement, 3′ miRNA section 42 has a length equal to the length of the miRNA divided by 2 rounded down to the nearest integer. The 3′ miRNA section 42 starts from the 3′ end of the miRNA. In a further refinement, the lengths of either 5′ miRNA section 40 or 3′ miRNA section 42 may be increased by 1 if there is a remainder.

In step c), expression patterns of the set 28 of mRNA sequences by categorizing each mRNA sequence as being up-regulated, down-regulated, or uncharged as compared to a control sample and each miRNA sequence in set 37 of miRNA sequences as being up-regulated, down-regulated, or uncharged as compared to the control sample. The control sample (i.e., a sample containing mRNA and miRNA) is chosen specifically for the situation being analyzed. For example, in evaluating a disease, the control sample will be derived from a subject not experiencing the disease. In evaluating a drug, the control sample will be derived from a subject not being given the drug. For each microRNA, a determination of which mRNA sequences that are susceptible to being regulated the microRNA is made (step d). In this step, a method for identifying potential targets for a given miRNA may be used. For example, methods associated portions of miRNA with the 3′ UTR of an mRNA may be utilized. An example of such a method is provided in B. P. Lewis et al., Conserved Seed Pairing, Often Flanked by Adenosines, Indicates that Thousands of Human Genes are MicroRNA TargetsCell, Vol. 120, 15-20, Jan. 14, 2005. The entire disclosure of this article is hereby incorporated by reference. Another example of a useful technique is found in provisional patent application No. 61/306,353, U.S. patent application Ser. No. 13/032,377 entitled MIRNA TARGET PREDICTION filed on Feb. 22, 2011 and the article New class of microRNA targets containing simultaneous 5′-UTR and 3′-UTR interaction, I. Lee et al., Genome Research, 19:1175-1183 (2008). The entire disclosures of these documents are hereby incorporated by reference. For example, potential targets are identified by a computer implemented method of identifying microRNA-mRNA complexes. The method comprises receiving data identifying an mRNA nucleotide sequence representing a gene or portions thereof into computer memory. The nucleotide sequence has an upstream region that is upstream of translation start site, a downstream region that is downstream of translation stop site, and an open reading frame. Data identifying a second set of microRNA (miRNA) nucleotide sequences is also received into computer memory. Each microRNA sequence of the second set has a 5′ miRNA section and a 3′ miRNA section. The downstream region is evaluated for sub-regions that are capable of stably hybridizing to at least of a portion of the 5′ miRNA section. Similarly, the upstream region is evaluated for sub-regions that are capable of stably hybridizing to at least of a portion of the 3′ miRNA section. Candidates for microRNA-mRNA complexes are identified as combinations of stably hybridizing sub-regions of the downstream section to portions of the 5′ miRNA section and stably hybridizing sub-regions of the upstream section to portions of the 3′miRNA section.

In step e), a set of consistent microRNA-mRNA relationships are identified. A consistent relationship is such that up regulation of a microRNA is associated with down regulation of mRNAs. A consistent relationship is also such that down regulation of a miRNA is associated with up regulation of mRNAs. In a refinement, a consistent relationship is also evaluated in the instance when a given mRNA is related to a plurality of microRNAs. In this instance, a consistent relationship is one in which up regulation of the mRNA is associated with down regulation of the microRNAs and vice versa. In another refinement, consistency is also evaluated by considering up regulation of microRNA with up regulation of all associated mRNA to be consistent. Similarly, consistency is also evaluated by considering down regulation of microRNA with down regulation of all associated mRNA to be consistent. In each of the criteria used to determine consistency, instances where the microRNA and mRNA are neither up nor down regulated (“not regulated”) are deemed not to be determinative of consistency. It should also be appreciated that up regulation, down regulation, or not regulated are determined from experiment expression patterns with in a predetermined ranges. In each instance, a given miRNA may interact with one or several mRNA and a given miRNA may interact with one or several mRNA. Inconsistent microRNA-mRNA relationships are excluded from future consideration. In a subsequent optional step, the miRNA is introduced into a cell expressing the mRNA to verify regulation of the mRNA by the miRNA. In a variation, a nucleic acid sequence (e.g., antisense-miRNA, microRNA sponge, anti-miR, etc) that blocks miRNA is introduced into a cell expressing the mRNA to verify regulation of the mRNA by the miRNA. Finally, the consistent microRNA-mRNA relationships are used for potential diagnostic or therapeutic targets.

In another variation, a non-transitory computer readable medium embodying a program of instructions executable by a computer processor to perform the method steps set forth above is provided. Specifically, the computer readable medium is encoded with instructions for the steps of the methods of the invention. Example of useful computer readable media include, but are not limited to, harddrives, floppy drives, CDROM, DVD, optical drives, random acess medium, and the like.

In a variation of the present embodiment, the MirFilter is applied by defining two separate gene expression spaces, one miRNA and the other mRNA. Vector spaces i and M, are defined. The eigenvectors of these spaces (here non-orthogonal, due to dependencies among genes) correspond to all miRNAs and mRNAs, respectively. Space i is described as matrix vector (Nᵢ×1) and M as (Nₘ×1) with each value corresponding to an eigenvector expression level. The index b=1, . . . , Nᵢ for miRNA and a=1, . . . , Nₘ for mRNA is used to describe eigenvectors î_{b} and \hat{M}ₐ. These two spaces can now be connected through a matrix rule. Regulation matrix R is defined as the first order mRNA regulation by miRNA; miRNA-regulated gene expression can thus be written as Ri=M, where (Nₘ×Nᵢ) matrix R includes only post-transcriptional direct regulation by miRNA. As there is no clear understanding of miRNA and mRNA processes, weighting or normalization parameters are not utilized. Instead, R_{ab}=1 if î_{b} regulates \hat{M}ₐ, and 0 if it does not. Disease-control gene expression experiments use mostly log expression fold changes for analysis, so that fold expression change vectors Δi (=i_{disease}−i_{control}) and ΔM (=M_{disease}−M_{control}) can be written as

$$R Δ i = Δ M , \\ where Δ {i}_{b} or Δ {M}_{a} = \{ \begin{matrix}+ 1 & if up \text{-} regulated \\ - 1 & if down \text{-} regulated \\ 0 & otherwise .\end{matrix} \qquad ( 1 )$$

Parameters related to fold change or statistical significance may be incorporated in the future.

After formulating the mRNA and miRNA expression change vector equation, MirFilter is run to obtain disease networks. A disease network is defined as disease-relevant connections between miRNAs and their common target mRNA with “exclusively” negatively correlated expressions. For that purpose, filtering matrices F and G are defined as (Nₘ×Nₘ) and (Nᵢ×Nᵢ) diagonal matrices, respectively, with elements

$$\begin{matrix}{F}_{{aa}^{′}} = 0 if a \neq {a}^{′} \\ {F}_{aa} = \{ \begin{matrix}1 & if {s}_{f} ( a ) = - 1 \\ 0 & otherwise ,\end{matrix} & ( 2 ) \\ where {s}_{f} ( a ) = \frac{{\sum }_{b} Δ {M}_{a} {R}_{ab} Δ {i}_{b}}{{\sum }_{b} \vert Δ {M}_{a} {R}_{ab} Δ {i}_{b} \vert} , & \\ {G}_{{bb}^{′}} = 0 if b \neq {b}^{′} \\ {G}_{bb} = \{ \begin{matrix}1 & if {s}_{g} ( b ) = - 1 \\ 0 & otherwise ,\end{matrix} \\ where {s}_{g} ( b ) = \frac{{\sum }_{a} Δ {M}_{a} {R}_{ab} Δ {i}_{b}}{{\sum }_{a} \vert Δ {M}_{a} {R}_{ab} Δ {i}_{b} \vert} . & ( 3 )\end{matrix}$$

Then the filtering equation

FRGΔi=ΔM (4)

will identify disease networks only when all differentially expressed miRNAs for one differentially expressed mRNA are negatively correlated to that mRNA expression (Eq. 2) and only when all differentially expressed mRNAs targeted by one differentially expressed miRNA are negatively correlated to that miRNA expression (Eq. 3). Eq. 4 eliminates noise, leaving only coherent signals obtained from the two platforms. Examples of such outcome networks are −1î₂−1î₉=+1\hat{M}₅ and +1î₄=−1\hat{M}₈. This current stringent filtering condition could be relaxed using a sigmoid function in F and G rather than the current step function.

### EXAMPLE 1

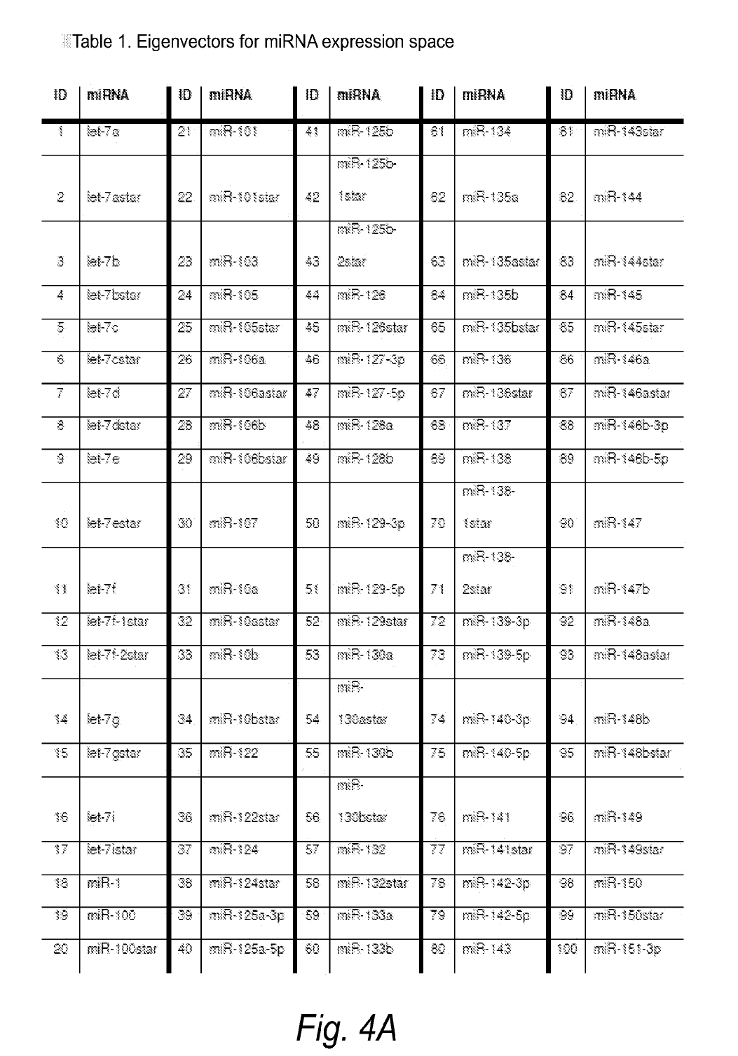

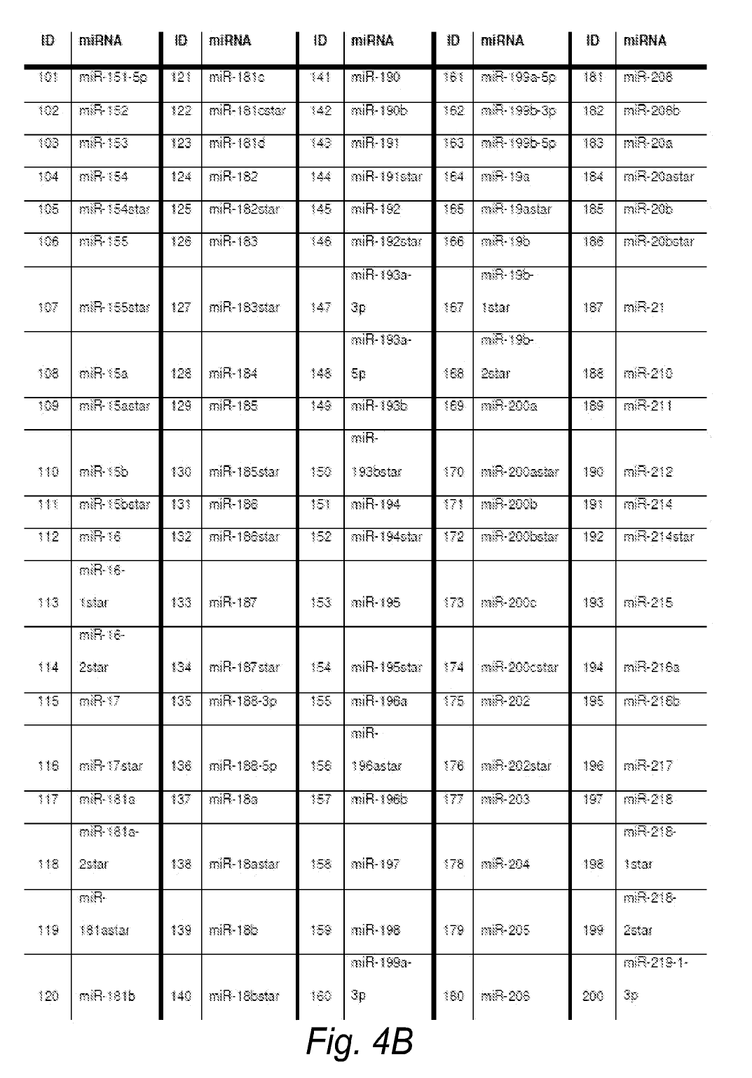

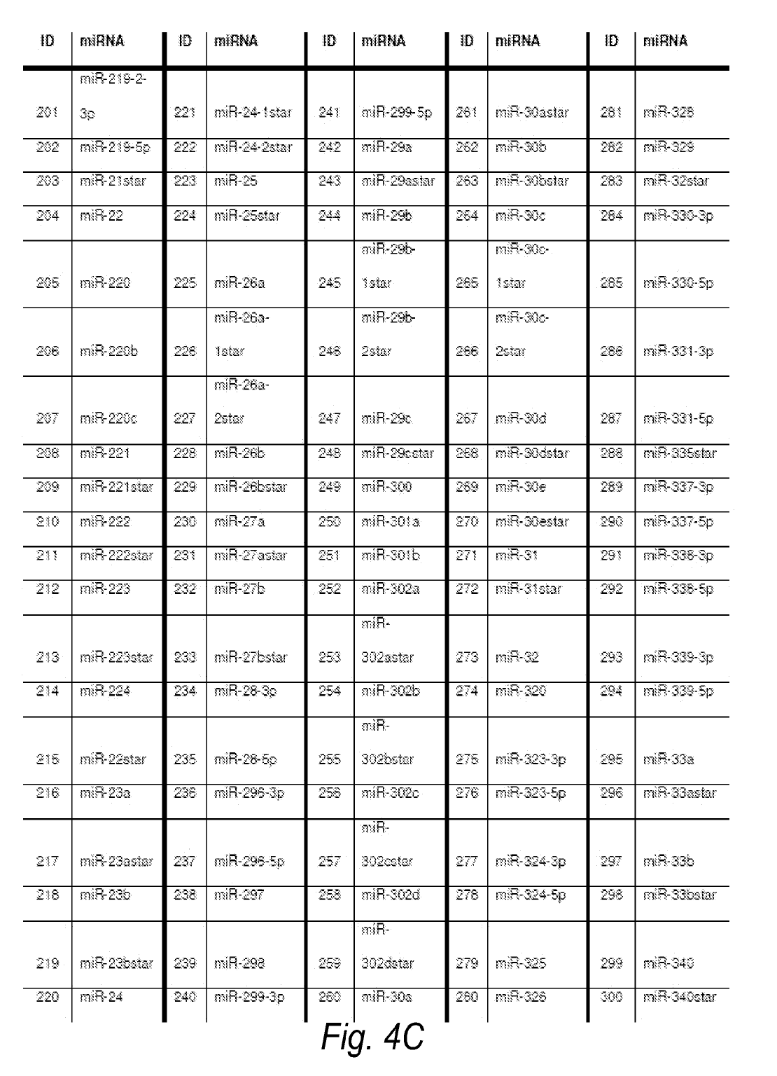

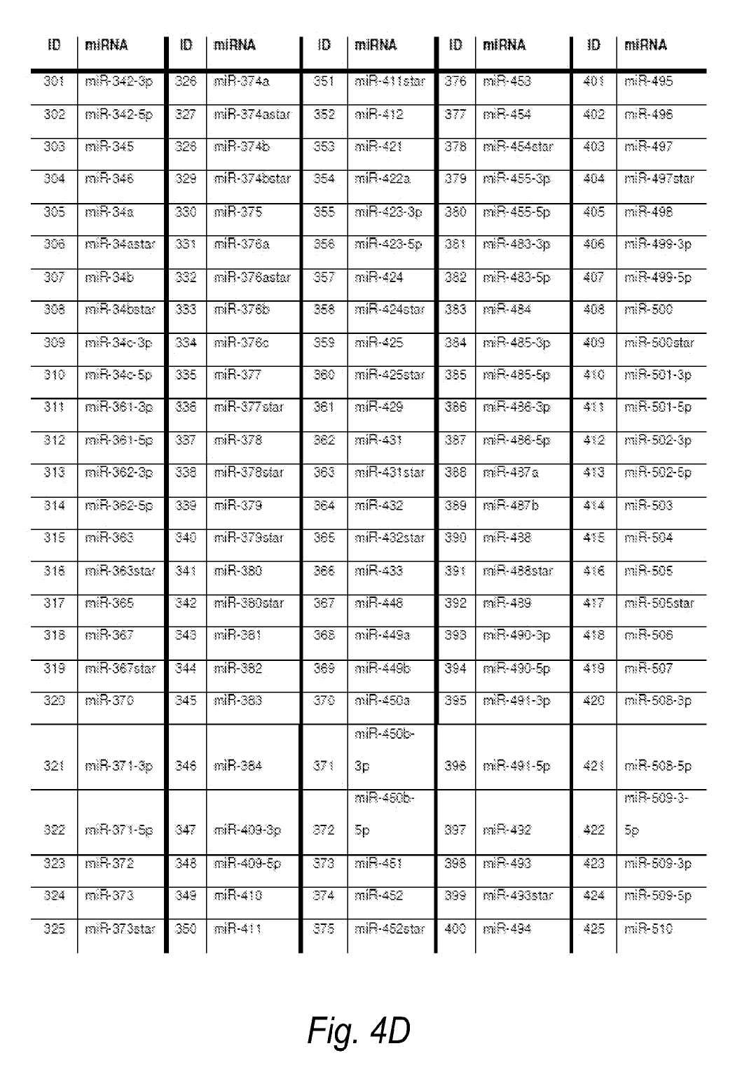

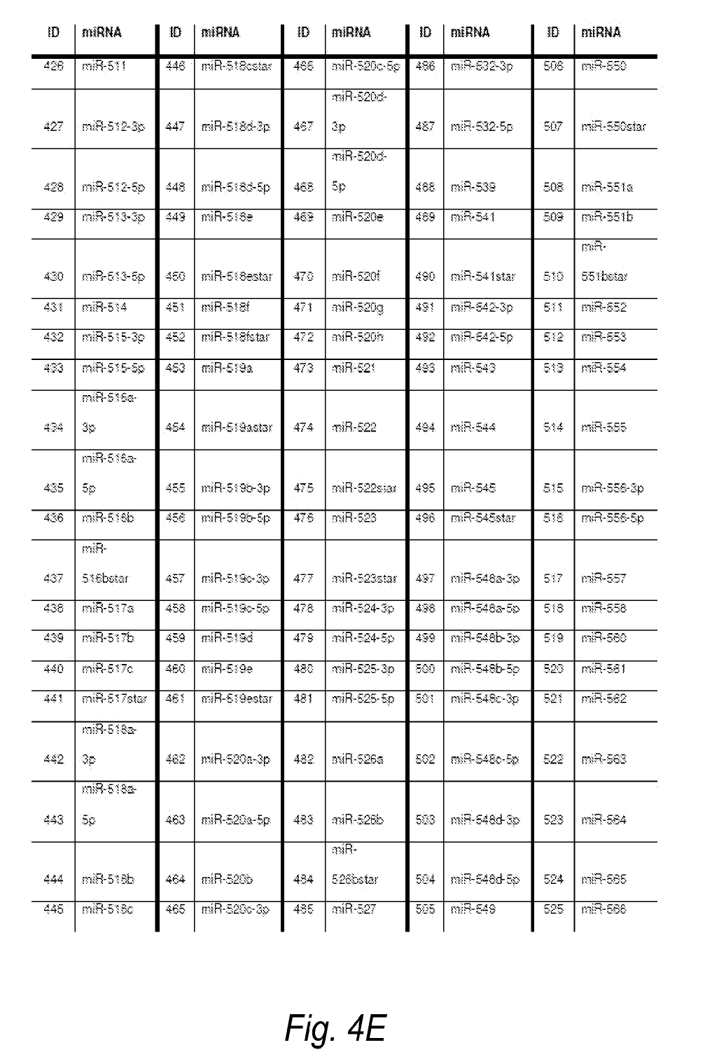

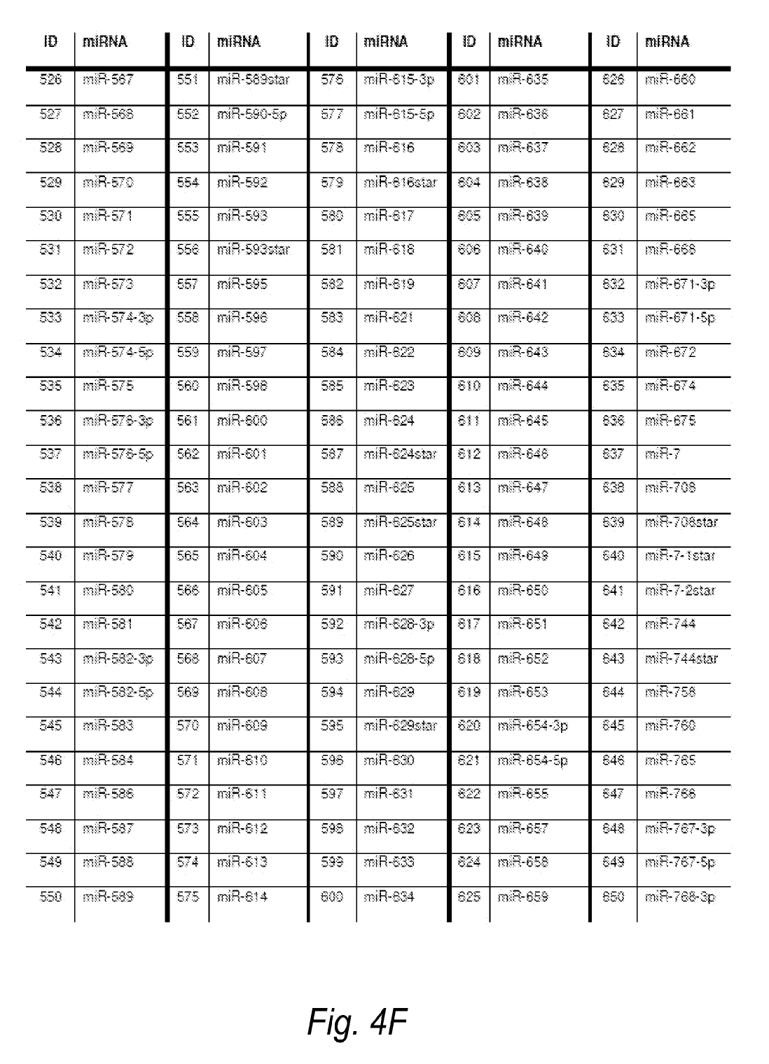

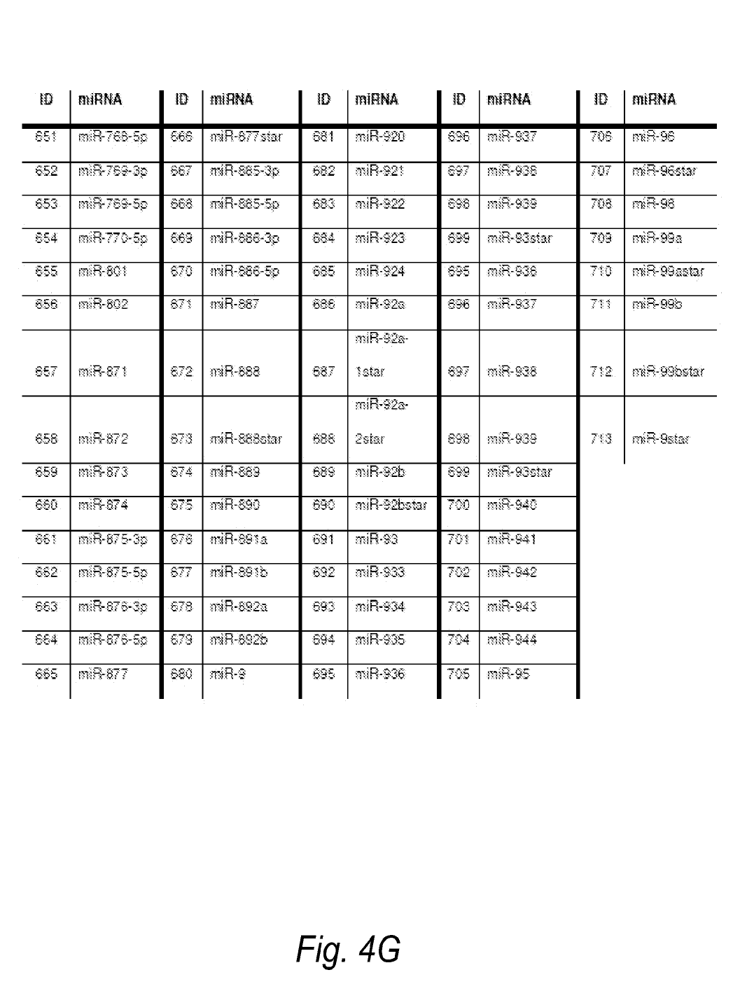

The article, New class of microRNA targets containing simultaneous 5′-UTR and 3′-UTR interaction, I. Lee et al., Genome Research, 19:1175-1183 (2008), identifies motifs in 5′ UTRs as potential miRNA interaction sites. The entire disclosure of this article is hereby incorporated by reference. Extending this finding, we prepared miRNAs and their target lists containing both 5′ and 3′ UTR interaction sites, without considering conservation information, and used them to create regulation matrix R. The mean number of target genes predicted in this way is 92, using 722 miRNAs from miRBase v.10.0, nine miRNAs being without targets (hsa-miR-149* has the maximum number of predicted targets, 762 (689 for hsa-miR-940 among non-star named miRNAs). Even though we calculated targets using RefSeq database sequences for mRNA, we will report using gene symbols for ease of comparison. Multiple transcripts for a single gene symbol will thus not be considered in this report. Genes identified as miRNA targets from our method are 11,245 (among a total of 17,255 genes whose 5′ and 3′ UTR are both annotated). Therefore, the dimension of R is 11,245×713. Among 11,245 genes, 2,830 are targeted by a single miRNA. KIAA0125 is predicted to have the largest number of regulating miRNAs, with 118 miRNAs, but its function is unknown, while RUNX1, whose function is somewhat known, is regulated by 96 miRNAs. Since our target numbers are considerably smaller than those from other conventional 3′ UTR target predictions, these miRNA-target lists can be considered a subset of miRNA and targets. Matrix R and eigenvectors of M are accessible from http://www.med.umich.edu/psych/pubs/2008/mirFilter/; miRNA eigenvectors of i are in the supporting online material Table 1 of FIG. 4.

We compared characteristics of our miRNAs and targets with those from TargetScan (A. Grimson et al., Mol Cell 27, 91 (Jul. 6, 2007).), a well-established miRNA target program with three kinds of prediction: 1) Conserved miRNAs across species and their targets with Conserved motifs (CC), 2) Conserved miRNAs across species and their targets with Less conserved motifs (CL), and 3) Non-conserved miRNAs across species and their targets (N). TargetScan does not distinguish among miRNA families. The total number of miRNA families for CC is 162, targeting a total 7,927 genes, resulting in 7,927×162 matrix R. With the same miRNA family number, on the other hand, the number of targets for CL is 17,256, covering most known genes. The dimensions of R for CL and N are 17,256×162 and 17,377×333, respectively. Quantitative comparisons of miRNA targets are detailed in the supporting online material.

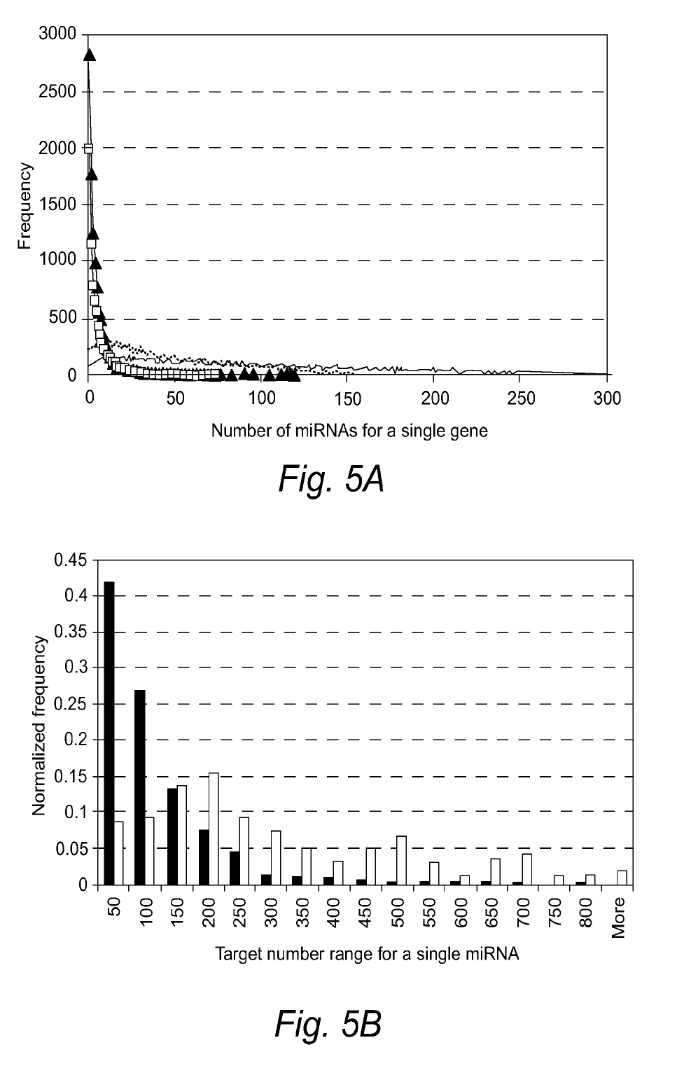

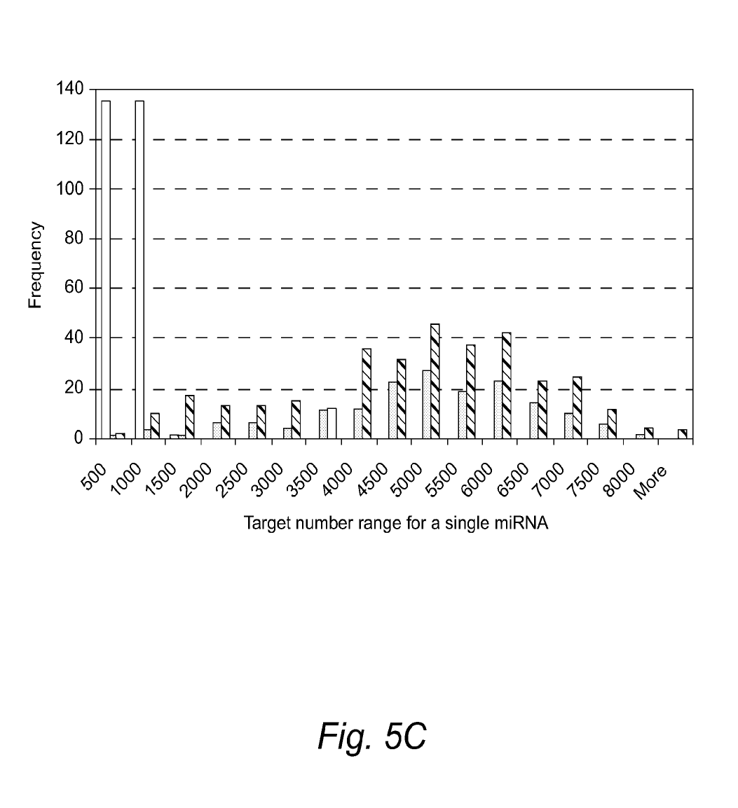

The number of targets in the MirFilter prediction is compared with those identified by the three TargetScan categories (A. Grimson et al., Mol Cell 27, 91 (Jul. 6, 2007).). We first evaluated the targets in terms of genes. The number of regulating miRNAs for a single gene is shown as a histogram in FIG. 5a. Similar L-shaped distributions are observed for our data and data from the CC category, while those from CL and N categories contain small Gaussian type peaks. Considering our miRNAs and targets do not include any conservation information, the similarity in histogram patterns (ours and CC's) is striking We then evaluated the targets in terms of miRNAs. The number of target genes for a single miRNA is shown in FIGS. 5b and 5c. Using our method, the mode of the distribution coincides in the 1-50 bin while the mode for the CC targets falls within the 150-200 bin (FIG. 5b). To better compare the number of targets for the three TargetScan categories we had to increase the bin size tenfold (1-500 for the lowest bin; FIG. 5c). Notice that this shifts the mode of the CC target distribution to the left end of the graph. In other words, our prediction that most miRNAs target few genes (FIG. 5b) is mirrored only in the CC category among TargetScan predictions. One difference between our prediction (FIG. 5b) and CC in FIG. 5c is that the highest miRNA frequency in the lowest target number bin remains the same for ours whatever bin size we use.

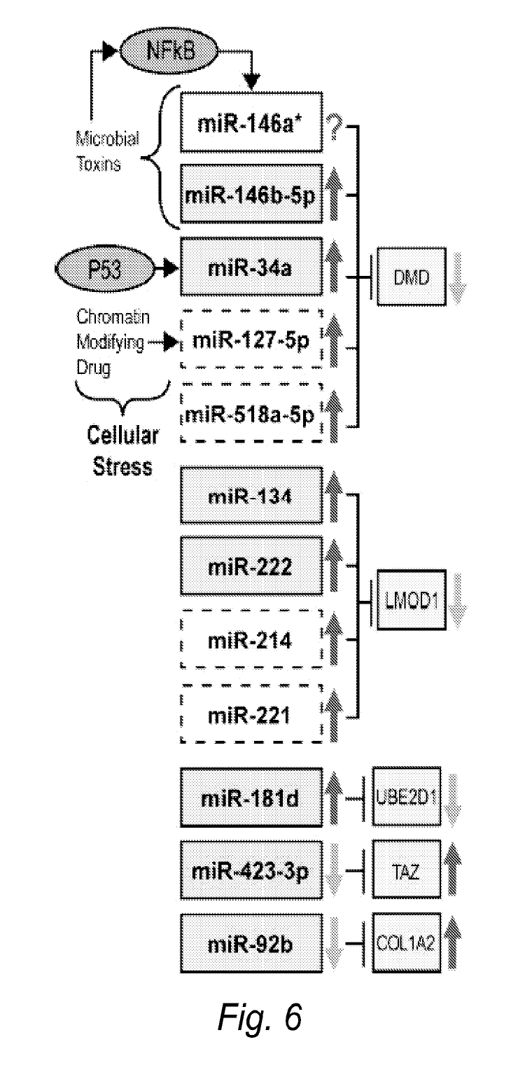

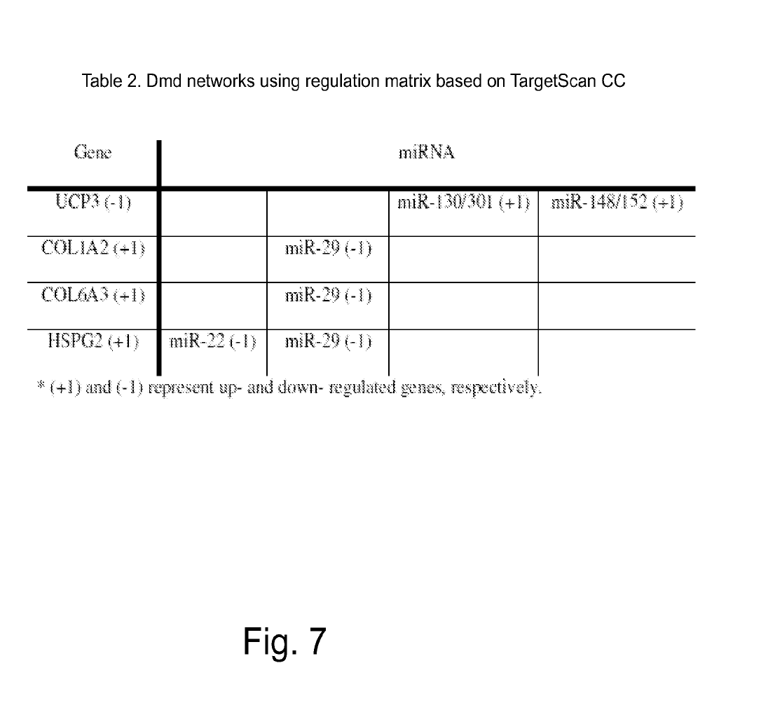

Recently, Eisenberg et al. reported on miRNA profiles of 10 different groups of muscle disorders, in addition correlating mRNA and predicted miRNA targets using mRNA expression data, reporting functional correlations for only two disease groups (I. Eisenberg et al., Proc Natl Acad Sci U S A 104, 17016 (Oct. 23, 2007)). As far as we know, this is the first paper reporting such correlations. We chose one of the correlated disorders, Duchenne muscular dystrophy (Dmd), as our test set for MirFilter, using the same samples in the correlation study without any additional microarray data analysis. The miRNA list was taken from Table 4 in Eisenberg et al.'s paper and the mRNA list from Table 5 in Haslett et al.'s paper (J. N. Haslett et al., Proc Natl Acad Sci U S A 99, 15000 (Nov. 12, 2002).) both from the same lab. All up- and down- regulated mRNAs and miRNAs reported in these tables and corresponding to our vector elements were assigned +1 and −1 in Δi and ΔM vectors, respectively. A total of 39 miRNAs were assigned to +1 and 24 miRNAs to −1, with 76 genes assigned to +1 and 17 genes to −1. Following MirFilter calculation, 5 genes were linked to miRNAs without any a priori knowledge. We schematize the output in FIG. 6. Among them, the dystrophin gene (DMD) was found to be targeted by miR-146b-5p and miR-34a. This network was conspicuous from the start (before knowing its symbol name), because it was also targeted by other up-regulated miRNAs. For example, miR-127-5p and miR-518a-5p were selected when we applied the FR filter rather than FRG in Eq. 2. Dmd is caused by an absence of dystrophin protein, with early childhood onset, survival being rare beyond the early 30s. Several articles suggest that miR-146b-5p and the DMD gene have the most fold changes, 13.02 and −5.896, among up-regulated miRNAs and down-regulated genes. This is interesting because our equation made no reference to fold change information. In addition, miR-146a and b were identified as endotoxin-responsive genes through their Toll-like receptor (TLR) response. (K. D. Taganov, M. P. Boldin, K. J. Chang, D. Baltimore, Proc Natl Acad Sci USA 103, 12481 (Aug. 15, 2006).) In particular, NF-κB was reported to promote miR-146a expression. Interestingly, Chen et al. investigated developmental timing of Dmd and reported strong induction of the NF-κB pathway by TLR7 before the onset of disease symptoms. (Y. W. Chen et al., Neurology 65, 826 (Sep. 27, 2005).) A subsequent mouse study found lowered NF-κB activation rescued dystrophin. (G. Bonuccelli et al., Cell Cycle 6, 1242 (May, 2007).) Pescatori et al. also recently confirmed massive induction of immune response and inflammation in the early phase of the disease (M. Pescatori et al., Faseb J 21, 1210 (April, 2007).) We now propose miRNA links between immune response and the DMD gene, based solely on MirFilter results. This leads us to a hypothesis that early childhood immune responses may induce related-miRNAs which in turn stop DMD protein production, resulting in disease symptoms around age 5. Though experimental confirmation is needed, we have demonstrated the feasibility of using MirFilter to isolate important pathways based on expression patterns. Note that miR-34a is known to be activated by p53 (G. T. Bommer et al., Curr Biol 17, 1298 (Aug. 7, 2007); L. He et al., Nature 447, 1130 (Jun. 28, 2007)). It seems that our disease network identified, without any prior knowledge, miRNAs responding to cellular stresses such as toxins and DNA-damaging agents. As a control, we used a regulation matrix R based on TargetScan predictions: 4 genes and 4 miRNAs were identified in the case of CC but neither DMD nor miR-146 and miR-34 were included (Table 2 in FIG. 7), nor was Eisenberg et al.'s miRNA-mRNA correlation (I. Eisenberg et al., Proc Natl Acad Sci U S A 104, 17016 (Oct. 23, 2007)), therefore distinguishing our target prediction method in terms of DMD. CL and N did not identify any network.

### EXAMPLE 2

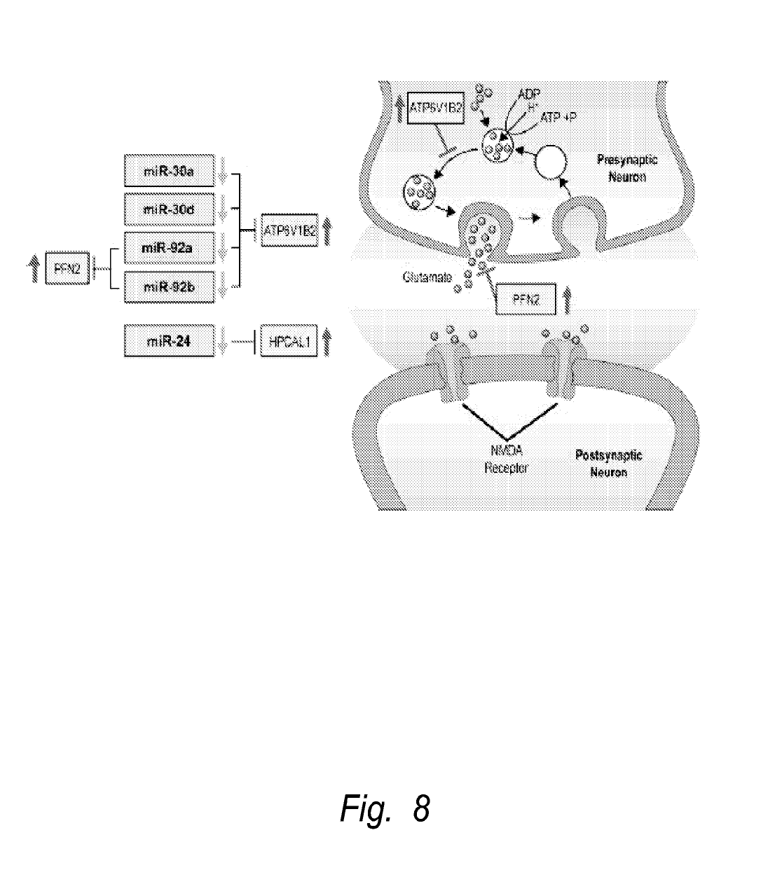

For our next test of MirFilter, we used expression patterns of schizophrenia (SZ). Unlike Dmd disorder, the pathology of SZ remains unclear, reflecting complex genetic factors. A genome-wide miRNA profile from brain tissue of individuals with SZ was recently published, reporting 16 differently expressed miRNAs compared to controls D. O. Perkins et al., Genome Biol 8, R27 (2007)). Among these, only one miRNA, miR-106b, was upregulated in the microarray data, while the downregulated miR-7 in the microarray data was found to be upregulated in the RT-PCR data. We used −1 for these two miRNAs and +1 for the other 15 miRNAs (corresponding to our vector annotation) in Δi. As for ΔM, we used Hakak et al.'s gene list in their Table 1 Y. Hakak et al., Proc Natl Acad Sci U S A 98, 4746 (Apr. 10, 2001). 70 genes were +1 and 17 genes −1. These datasets from two different groups used similar brain regions (prefrontal cortex) with sample sizes totaling 36 (miRNA) and 24 (gene chip), including controls. The up- and down-regulated gene numbers in the expression vector are comparable to the Dmd case, but miRNA numbers significantly lower and highly skewed to down-regulation. It would be expected that many genes would slip through the filtering process. Nevertheless, MirFilter identified just three disease networks (FIG. 8). ATP6V1B2 is especially intriguing statistically, as all four miRNAs predicted to target ATP6V1B2 in the regulation matrix R were found to be exclusively and negatively correlated with ATP6V1B2 expression. Profilin-2 gene (PFN2) is not as statistically significant as ATP6V1B2, since two outcome miRNAs, miR-92a and b, out of a total 11 regulating miRNAs, are in the same family. However, a recent study reported that the actin-binding PFN2 protein apparently reduced synaptic vesicle exocytosis and presynaptic excitability P. Pilo Boyl et al., Embo J 26, 2991 (Jun. 20, 2007). Vacuolar-ATPase (V-ATPase) is also known to affect neurotransmitter uptake in the synaptic vesicle before its release at the presynaptic plasma membrane (T. Nishi, M. Forgac, Nat Rev Mol Cell Biol 3, 94 (February, 2002)). The function of V-ATPase subunit ATP6V1B2 is not well known. Being in the V1 domain, however, ATP6V1B2 should play a role in neurotransmitter storage in the vesicle rather than in presynaptic membrane docking for fusion.

We thus propose that ATP6V1B2 upregulation delays neurotransmitter release, so that PFN2 and ATP6V1B2 upregulation will dampen presynaptic excitement. Hyposensitivity of postsynaptic glutamate receptors has been linked with SZ pathology (a glutamate receptor antagonist can cause SZ symptoms). Our SZ findings characterize a stage prior to postsynaptic receptor hyposensitivity. A recent study has confirmed the upregulation (>2-fold) of ATP6V1B2 protein levels in the white matter of SZ patients, with an ANOVA p-value of 9×10⁻⁵, lowest among all identified proteins (18), implying reduced exocytosis from glial cells. Again, MirFilter yielded networks highly relevant to SZ using hypothesis-free data analysis.

### Conclusions

In two separate cases, MirFilter allowed us to identify networks highly relevant to diseases of interest without any bias from prior knowledge. Note that MirFilter identified networks related to the central features of each disease, even without large sample numbers or cohort, suggesting applications in individualized medicine.

### EXAMPLE 3

The National Cancer Institute provides extensive data on the 60 human cancer cell lines derived from diverse tissues including brain, blood, breast, colon, kidney, lung, ovary, prostate through CellMiner database (http://discover.nci.nih.gov/cellminer/loadDownload.do). Among them, 10 cell lines are classified as metastatic cell lines. We downloaded expression data of mRNA, protein, and miRNA of all 60 cell lines and applied mirFilter process.
1) Metastatic signature from NCI 60 cell line data

Among the 10 metastatic cell lines, we used 9 of them (excluding LOXIMVI cell line due to its non-metastatic behaviors reported by several groups) for metastatic expression pattern signature and the rest 50 cancer cell lines for non-metastatic expression pattern signature. The expression data of these two groups were compared to identify significantly up- and down-regulated mRNAs, miRNAs, and proteins in the metastatic cancer lines.
a. miRNA and mRNA expression comparison

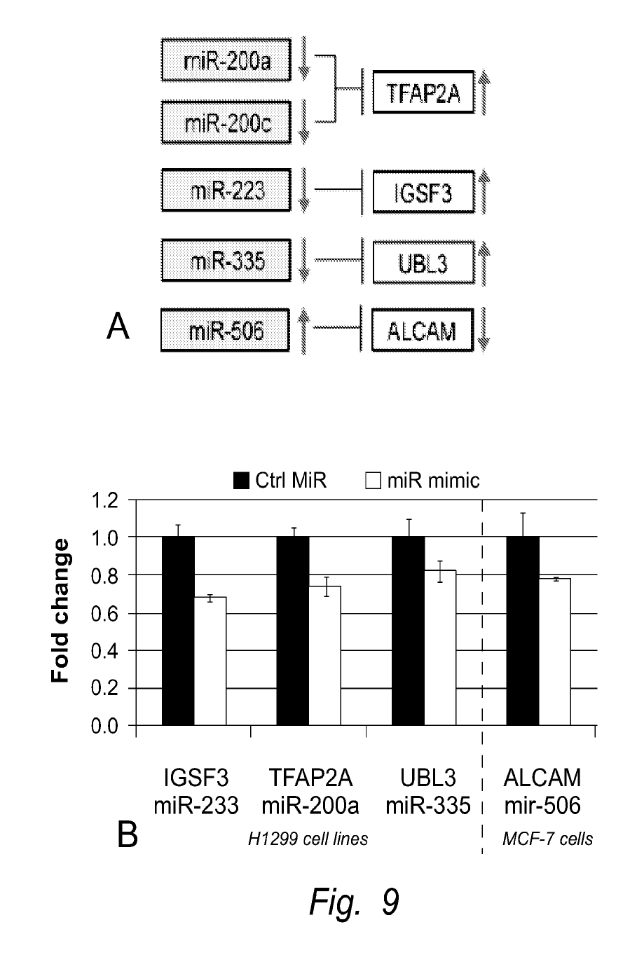

When we used significance cutoff to be more than 2 fold changes, total 4 miRNA-mRNA pairs (both miR-200a and 200c, the same miRNA family, are targeting TFAP2A) were mirFilter outputs (FIG. 9A). Among them, 2 miRNAs are well known metastatic miRNAs and all of the pairs were validated with luciferase assays as shown in the FIG. 9B.
b. miRNA and protein expression comparison

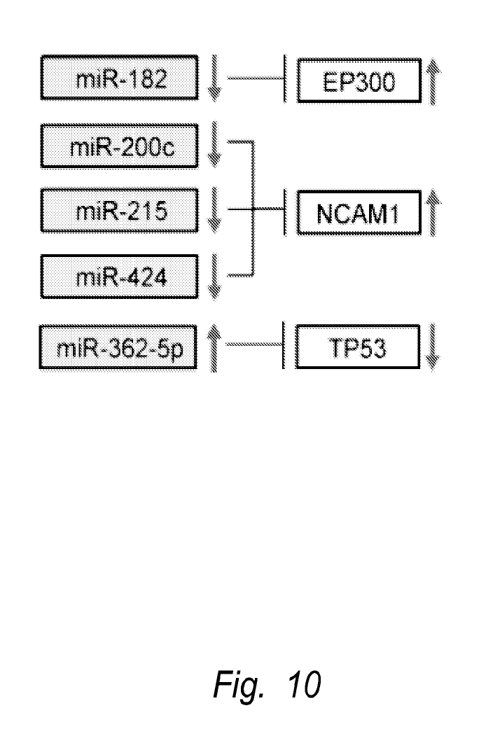

FIG. 10 shows the mirFilter outputs using protein expression rather than mRNA expression. Using totally different coding gene expression data (none of mRNA expressions of the FIG. 10 output genes was in the significantly changed mRNA expression dataset), we still identified miR-200c important as a metastatic signature. In addition, TP53 protein was picked out as metastatic signature, its level being significantly lower in metastatic cell lines confirming previous knowledge of TP53 effects on metastasis though its mRNA level was not. Considering the translational repression function of miRNAs, this discrepancy between TP53's mRNA and protein levels may reflect a miRNA function in metastasis.
2) Leukemia

A similar analysis was performed comparing blood cell line and other cells to obtain Leukemia signatures. The following table provides well known leukemia miRNA signatures of miR-17-92 clusters.

| upmiR, downsym | downmiR, upsym |
|---|---|
| miR-106a, miR-17, miR-20a, b --\| CALD1, | miR-455-5p: SFRS18 |
| TSPAN4 | miR-525-3p: CSK |
| miR-20b --\| MALL | |
| miR-142-3p --\| ARHGAP12, (CTNND1: | |
| c7n7) | |
| miR-106a* --\| TRIM16 | |
| miR-92a-1*: ERBB3 | |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer implemented method of identifying potential micoRNA targets, the method comprising:
a) receiving data identifying a first set of mRNA sequences into computer accessible memory, each mRNA sequence in the set having a region that is upstream of a translation start site, a region that is downstream of a translation stop site, and an open reading frame;
b) receiving data identifying a second set of microRNA (miRNA) sequences into the computer accessible memory, each microRNA sequence having a 5′ miRNA section and a 3′ miRNA section;
c) categorizing each mRNA sequence in the first set as being up-regulated, down-regulated, or uncharged as compared to a control sample and each miRNA sequence in the second set as being up-regulated, down-regulated, or uncharged as compared to the control sample;
d) determining which mRNA sequences from the first set are susceptible to being regulated by microRNA from the second set; and
e) identifying a set of consistent relationships between the miRNA and the mRNA determined in step d), a consistent relationship being a relationship in in which up regulation of an mRNA is associated with down regulation of an associated microRNA and down regulation of the mRNA is associated with up regulation of the associated microRNA or up regulation of an mRNA is associated with up regulation of an associated microRNA and down regulation of the mRNA is associated with down regulation of the associated microRNA.

2. The method of claim 1 further comprising:
f) introduced microRNA identified in step e) into a cell expressing the mRNA to verify regulation of the mRNA by the miRNA.

3. The method of claim 1 further comprising introducing a nucleic acid sequence that blocks miRNA into a cell expressing the mRNA to verify regulation of the mRNA by the miRNA.

4. The method of claim 1 wherein step c) is performed by using mRNA expression patterns.

5. The method of claim 1 wherein step c) is performed by using miRNA expression patterns.

6. The method of claim 1 wherein step d) is performed by determining if the 3′ UTR of a mRNA is can hybridize with a portion of the miRNA.

7. The method of claim 1 wherein step d) is performed by determined if the 5′ UTR of a mRNA is can hybridize with a portion of the miRNA

8. The method of claim 1 wherein the region that is upstream of a translation start site includes a 5′ UTR and the region that is downstream of the translation stop site includes a 3′ UTR.

9. The method of claim 6 wherein step d) is performed by determining if the 3′ UTR of a mRNA can hybridize with the 5′ miRNA section of the miRNA and the 5′ UTR of a mRNA can hybridize with the 3′ miRNA section of the miRNA.

10. A non-transitory computer readable medium having instructions encoding thereon, the instructions executable by a computer processor to perform the steps:
a) receiving data identifying a first set of mRNA sequences into computer accessible memory, each mRNA sequence in the set having a region that is upstream of a translation start site, a region that is downstream of a translation stop site, and an open reading frame;
b) receiving data identifying a second set of microRNA (miRNA) sequences into the computer accessible memory, each microRNA sequence having a 5′ miRNA section and a 3′ miRNA section;
c) categorizing each mRNA sequence in the first set as being up-regulated, down-regulated, or uncharged as compared to a control sample and each miRNA sequence in the second set as being up-regulated, down-regulated, or uncharged as compared to the control sample;
d) determining which mRNA sequences from the first set are susceptible to being regulated by microRNA from the second set; and
e) identifying a set of consistent relationships between the miRNA and the mRNA determined in step d), a consistent relationship being a relationship in in which up regulation of an mRNA is associated with down regulation of an associated microRNA and down regulation of the mRNA is associated with up regulation of the associated microRNA or up regulation of an mRNA is associated with up regulation of an associated microRNA and down regulation of the mRNA is associated with down regulation of the associated microRNA.
